(19) United States
(12) Patent Application Publication
(10) Pub. No.: US 2026/0225862 A1
(43) Pub. Date: Aug. 6, 2026

(54) BASE FOR SUPPORTING A LIFT SYSTEM IN A NACELLE OF A WIND TURBINE

(71) Applicant: LiftWerx Solutions Inc., Cambridge (CA)

(72) Inventors: John VEALE, Kitchener (CA); Christopher George THOM, Cochrane (CA)

(73) Assignee: LiftWerx Solutions Inc., Cambridge (CA)

(21) Appl. No.: 19/150,995

(22) PCT Filed: Jan. 24, 2024
(86) PCT No.: PCT/CA2024/050079

§ 371 Date: Jul. 25, 2025

Related U.S. Application Data
(60) Provisional application No. 63/443,788, filed on Feb. 7, 2023.

(51) Int. Cl. B66C 23/18; F03D 80/50

(52) U.S. Cl. CPC B66C 23/185; F03D 80/502

(57) ABSTRACT

A base for supporting a lift system in a nacelle of a wind turbine involves a pillow block mount mountable on the pillow block through studs. A longitudinal beam pivotally connected to the pillow block mount is pivotable about a horizontally oriented axis transverse to the longitudinal axis of the longitudinal beam. A beam support is connected to the longitudinal beam to support the longitudinal beam on a main bearing of the wind turbine proximate the distal end of the longitudinal beam. A jack is situated proximate the distal end of the longitudinal beam to engage the longitudinal beam and a bedplate of the nacelle to raise and lower the distal end of the longitudinal beam to pivot the longitudinal beam about the horizontally oriented axis. The base permits the lift system to lift the main bearing, the rotor or the gearbox with little or no reconfiguration of the base.

### CROSS-REFERENCE TO RELATED APPLICATIONS

This application claims the benefit of U.S. Provisional Patent Application Ser. No. 63/443,788 filed Feb. 7, 2023, the entire contents of which is herein incorporated by reference.

### FIELD

This application relates to wind turbines, in particular a base for supporting a lift system in a nacelle of a wind turbine.

### BACKGROUND

Wind turbine components, such as the rotor and the main bearing, are mounted and dismounted from the nacelle of the wind turbine by the use of lift systems (e.g., cranes). Large, ground-based cranes may be used, but the use of such cranes is costly and the availability of such cranes is limited, thereby increasing the cost and time of service operations on wind turbines. As such, nacelle-mounted lift systems have been developed. A nacelle-mounted lift system is mounted in the nacelle by lifting components of the lift system up to the nacelle using a pre-installed service crane and then the components are assembled inside the nacelle to provide a lift system that can handle heavy turbine components such as the rotor and the main bearing. It is desirable that a single lift system perform multiple lifting operations once mounted in the nacelle, but there are only a few places in the nacelle where a lift system can be supported thereby limiting the versatility of the lift system. To utilize a single lift system for different lifting operations, it is necessary to reconfigure the lift system in the nacelle. Danish patent application DK 202170204 filed May 3, 2021 describes such a system in which the support base for the nacelle-mounted lift system can be reconfigured to permit the lift system to access different wind turbine components. Problems arise because the base on which the lift system is supported can prevent access by the lift system to certain wind turbine components necessitating the addition of extra supporting elements to reconfigure the base to provide access to those certain wind turbine components.

There remains a need for a base for supporting a lift system in the nacelle of a wind turbine, which requires no or less reconfiguring to switch from lifting one wind turbine component to another, especially for switching between lifting a main bearing and a rotor.

### SUMMARY

A base for supporting a lift system in a nacelle of a wind turbine comprises: a pillow block mount configured to be supported on a pillow block in the nacelle of the wind turbine, the pillow block mount mountable on the pillow block through studs connecting the pillow block mount to the pillow block; a longitudinal beam pivotally connected to the pillow block mount, the longitudinal beam having a longitudinal axis, a proximal end proximate the pillow block mount and a distal end remote from the pillow block mount, the longitudinal beam pivotable about a horizontally oriented axis transverse to the longitudinal axis of the longitudinal beam; a beam support connected to the longitudinal beam, the beam support configured to support the longitudinal beam on a main bearing of the wind turbine proximate the distal end of the longitudinal beam; and, a jack situated proximate the distal end of the longitudinal beam, the jack operable to engage the longitudinal beam and a bedplate of the nacelle to raise and lower the distal end of the longitudinal beam to pivot the longitudinal beam about the horizontally oriented axis.

In some embodiments, the jack comprises an extensible actuator, preferably a hydraulic cylinder. In some embodiments, the jack is rigidly attached to the longitudinal beam. In some embodiments, the jack is releasably attached to the longitudinal beam to permit rigidly attaching the jack at different locations along the longitudinal beam. In some embodiments, the longitudinal beam has a center of gravity, the center of gravity located between the jack and the horizontally oriented axis about which the longitudinal beam pivots. In some embodiments, the horizontally oriented axis is proximate the pillow block mount. In some embodiments, the horizontally oriented axis is at the pillow block mount.

In some embodiments, the base further comprises a trunnion mount assembly. In some embodiments, the trunnion mount assembly comprises the pillow block mount and a beam receiver. In some embodiments, the pillow block mount comprises at least one transversely oriented trunnion pin located on the horizontally oriented axis about which the longitudinal beam pivots. In some embodiments, the beam receiver is pivotally mounted to the pillow block mount through the at least one trunnion pin. In some embodiments, the longitudinal beam is non-pivotably attached to the beam receiver such that the longitudinal beam pivots about the at least one trunnion pin when the beam receiver pivots about the at least one trunnion pin. In some embodiments, the at least one trunnion pin comprises two trunnion pins. In some embodiments, the longitudinal beam is releasably attached to the beam receiver. In some embodiments, the longitudinal beam is pinned to the beam receiver by at least one receiver pin.

In some embodiments, the beam support is removably connected to the longitudinal beam to permit exchanging the beam support for a different beam support.

In some embodiments, the pillow block is a front pillow block.

In some embodiments, the pillow block mount comprises first and second pillow block mounts. In some embodiments, the longitudinal beam comprises first and second longitudinal beams pivotally connected to the first and second pillow block mounts, respectively. In some embodiments, the beam support comprises first and second beam supports connected to the first and second longitudinal beams, respectively. In some embodiments, the jack comprises first and second jacks operable to engage the first and second longitudinal beams, respectively. In some embodiments, the first and second pillow block mounts are transversely spaced apart and supported on respective pillow blocks when the base is in the nacelle with a main shaft of the wind turbine situated between the first and second pillow block mounts. In some embodiments, the base further comprises a transverse connecting beam on which the lift system is supported in the nacelle over the main shaft, the connecting beam spanning the first and second pillow block mounts.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a left side rear top view of an interior of a nacelle of a wind turbine in which a lift system is supported on a base mounted in the nacelle.

FIG. 2 depicts a left side front top view of the interior of the nacelle of FIG. 1.

FIG. 3 depicts a left side view of the interior of the nacelle of FIG. 1.

FIG. 4 depicts a left side front bottom view of the interior of the nacelle of FIG. 1

FIG. 5 depicts a left side view of the interior of the nacelle of FIG. 1 with the lift system and certain components of the base removed.

FIG. 6 depicts a right side view of the interior of the nacelle of FIG. 5.

FIG. 7 depicts a top view of the interior of the nacelle of FIG. 5.

FIG. 8 depicts a left side top view of the interior of the nacelle of FIG. 5.

FIG. 9 depicts a left side bottom view of the interior of the nacelle of FIG. 5.

FIG. 10 depicts a top front perspective view of a left-hand portion of the base in which a first longitudinal beam is pivotally connected to a first pillow block mount.

FIG. 11 depicts a bottom front perspective view of the portion of the base of FIG. 10.

FIG. 12 depicts a side view of the portion of the base of FIG. 10.

FIG. 13 depicts a rear view of the portion of the base of FIG. 10.

FIG. 14A depicts an exploded top perspective view of the portion of the base of Fig. showing the first longitudinal beam disconnected from the first pillow block mount.

FIG. 14B depicts a magnified bottom perspective view of FIG. 14A.

FIG. 15 depicts a side view of a right-hand portion of the base in which a second longitudinal beam is pivotally connected to a second pillow block mount.

FIG. 16 depicts a top view of the portion of the base of FIG. 15.

FIG. 17A depicts a bottom front view of the portion of the base of FIG. 15.

FIG. 17B depicts bottom rear view of the portion of the base of FIG. 15.

FIG. 18A depicts a magnified front left side view of the interior of the nacelle of Fig. showing the base supported on a main bearing of the wind turbine.

FIG. 18B depicts a left side view of FIG. 18B.

FIG. 19A depicts a magnified front left side view of the interior of the nacelle of Fig. showing the base supported on a bedplate of the nacelle instead of on the main bearing.

FIG. 19B depicts a left side view of FIG. 19B.

FIG. 20A depicts front top perspective views of two different longitudinal beam configurations adapted for different main bearing configurations.

FIG. 20B depicts top views of the two different longitudinal beam configurations of FIG. 20A.

FIG. 20C depicts front views of the two different longitudinal beam configurations of FIG. 20A.

FIG. 20D depicts side views of the two different longitudinal beam configurations of FIG. 20A.

### DETAILED DESCRIPTION

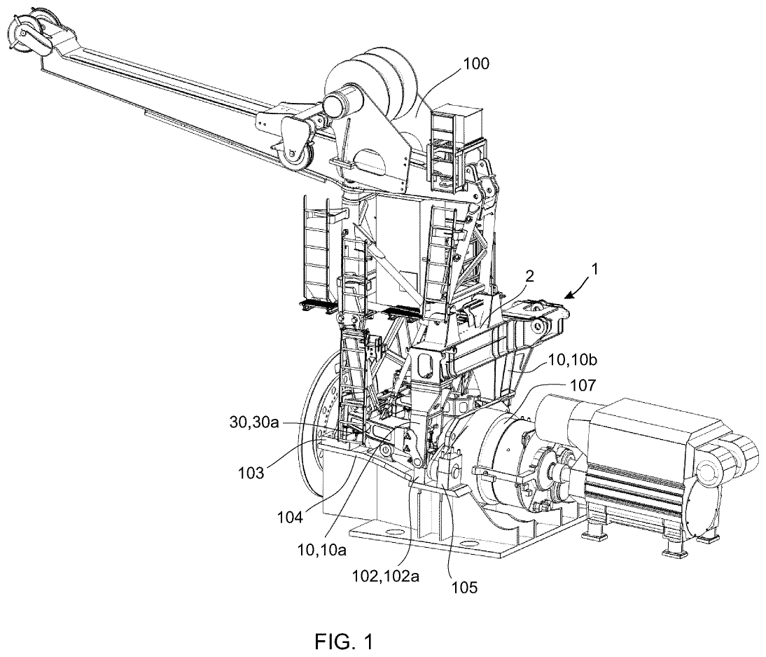

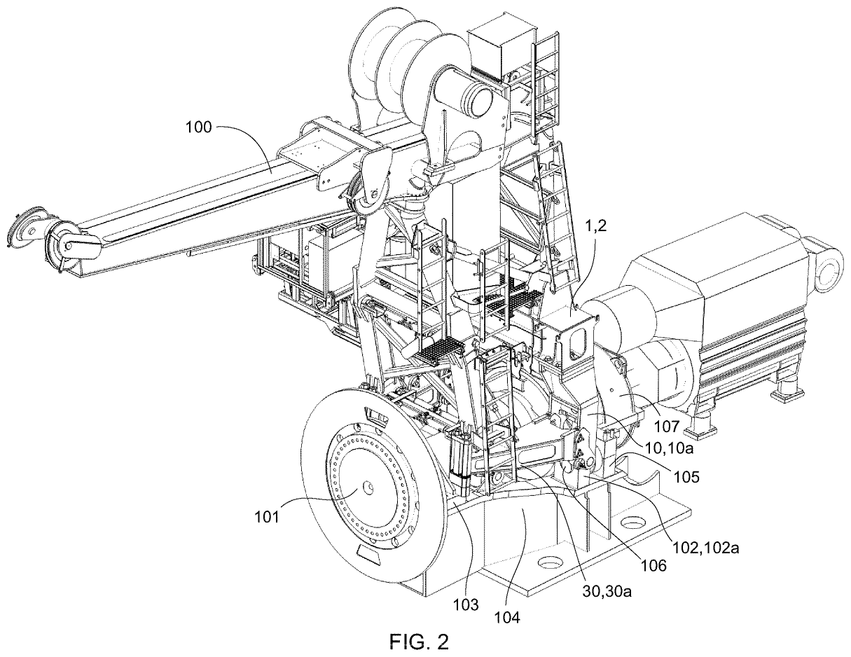

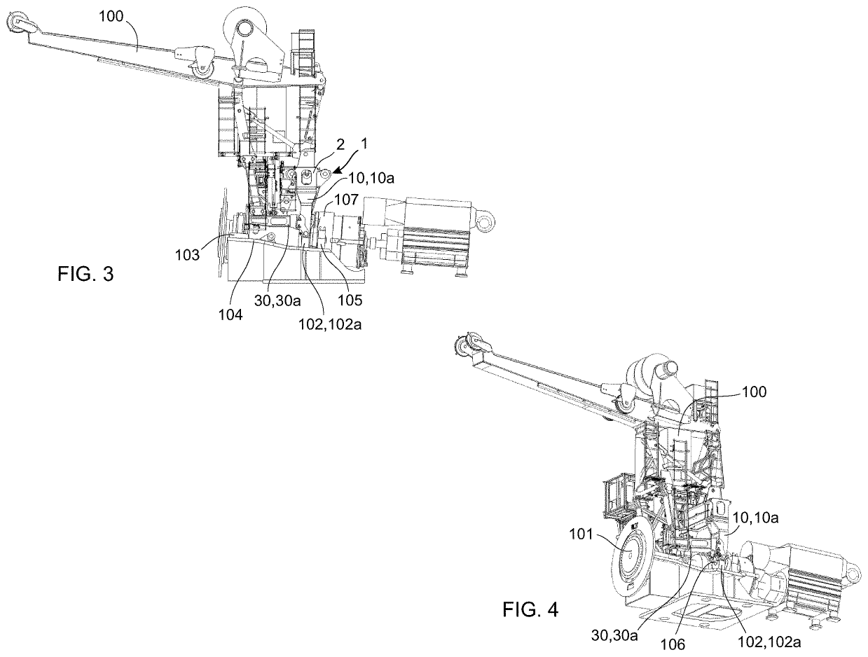

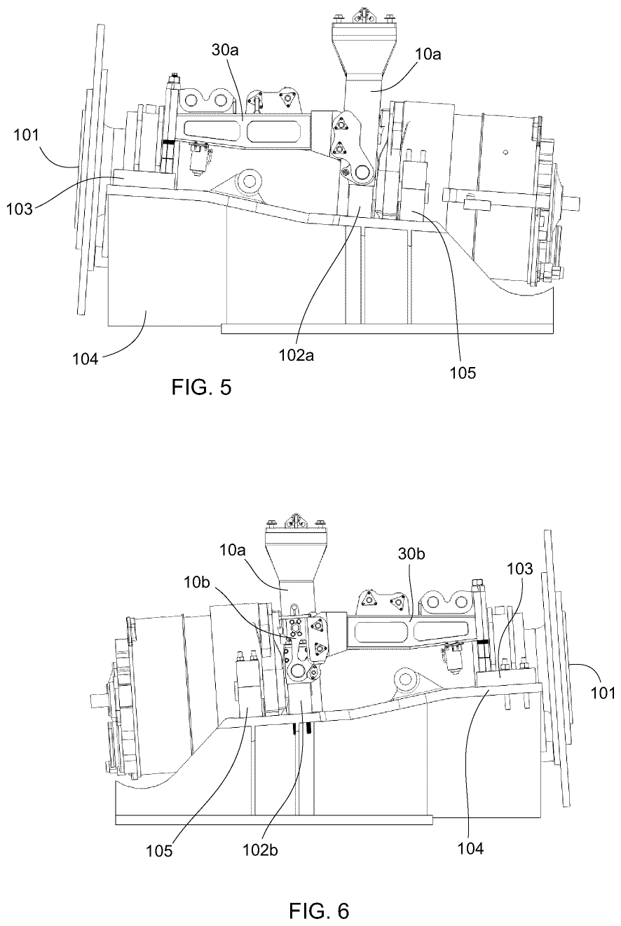

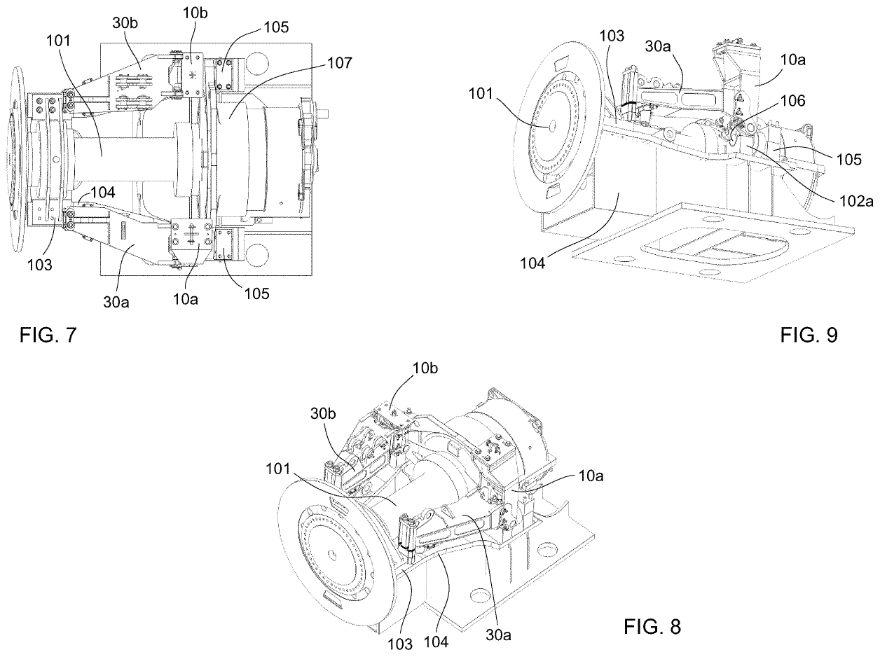

FIG. 1 to FIG. 4 provide context and depict an interior of a nacelle of a wind turbine in which a lift system 100 is supported on a base 1 mounted in the nacelle beside and over a main shaft 101 of the wind turbine. FIG. 5 to FIG. 9 provide further context for the base 1 illustrating the base 1 in the nacelle but with all the components of the lift system 100 removed. The base 1 is supported in the nacelle on front pillow blocks 102, including a left front pillow block 102a and a right front pillow block 102b (see FIG. 6), and on a main bearing 103 of the wind turbine. Rear pillow blocks 105 are located rearward of the front pillow blocks 102. In the illustrated embodiment, the rear pillow blocks 105 are not used to support the base 1, and are not needed to support the base 1, but in some embodiments the rear pillow blocks 105 could be utilized, if desired.

The base 1 comprises two trunnion mount assemblies 10, including a first trunnion mount assembly 10a and a second trunnion mount assembly 10b, that are transversely spaced apart in the nacelle and supported on respective front pillow blocks 102a and 102b when the base 1 is in the nacelle with the main shaft 101 situated between the first and second trunnion mount assemblies 10a and 10b, respectively. The first trunnion mount assembly 10a is situated on the left side of the main shaft 101 and the second trunnion mount assembly 10b is situated on the right side of the main shaft 101, when looking from rear to front of the nacelle. The base 1 further comprises a transverse connecting beam 2 on which the lift system 100 is supported in the nacelle over the main shaft 101. The connecting beam 2 is connected to and spans the two trunnion mount assemblies 10. The base 1 also comprised two longitudinal beams 30, including a first longitudinal beam 30a and a second longitudinal beam 30b, that are transversely spaced apart in the nacelle and pivotably connected at, or proximate, proximal ends thereof to respective trunnion mount assemblies 10a and 10b when the base 1 is in the nacelle with the main shaft 101 situated between the first and second longitudinal beams 30a and 30b, respectively. The first longitudinal beam 30a is situated on the left side of the main shaft 101 and the second longitudinal beam 30b is situated on the right side of the main shaft 101, when looking from rear to front of the nacelle. The two longitudinal beams 30 are supported at, or proximate, distal ends thereof on the main bearing 103.

The lift system 100 is supported on the connecting beam 2, which is supported on the two trunnion mount assemblies 10, which in turn are supported on the front pillow blocks 102 of the wind turbine, the front pillow blocks 102 being attached to and supported on a bedplate 104 of the nacelle. The lift system 100 is also supported on the two longitudinal beams 30 through a frame structure connected to various lugs 31 attached to the longitudinal beams 30. In the configuration illustrated in FIG. 1 to FIG. 4, the base 1 can support the lift system 100 so that the lift system 100 can handle a rotor or an individual rotor blade (not shown) of the wind turbine.

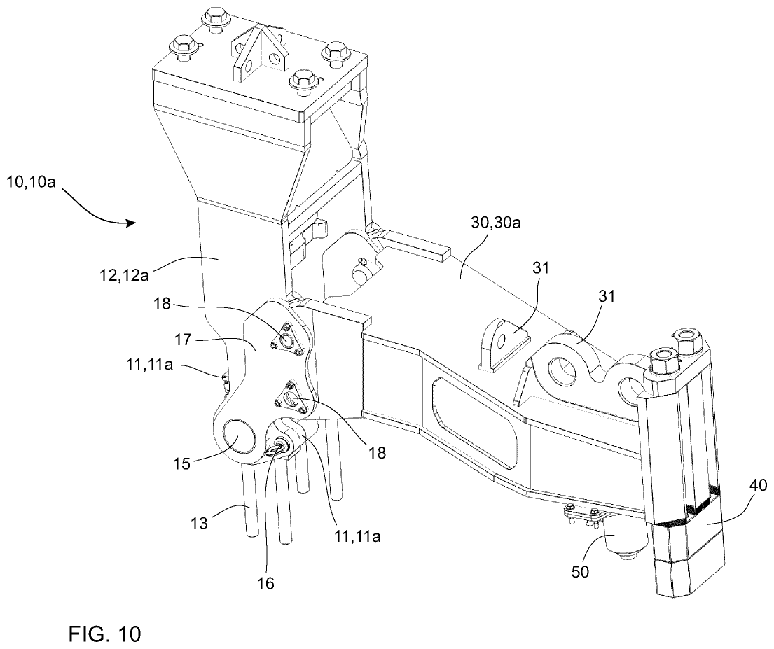

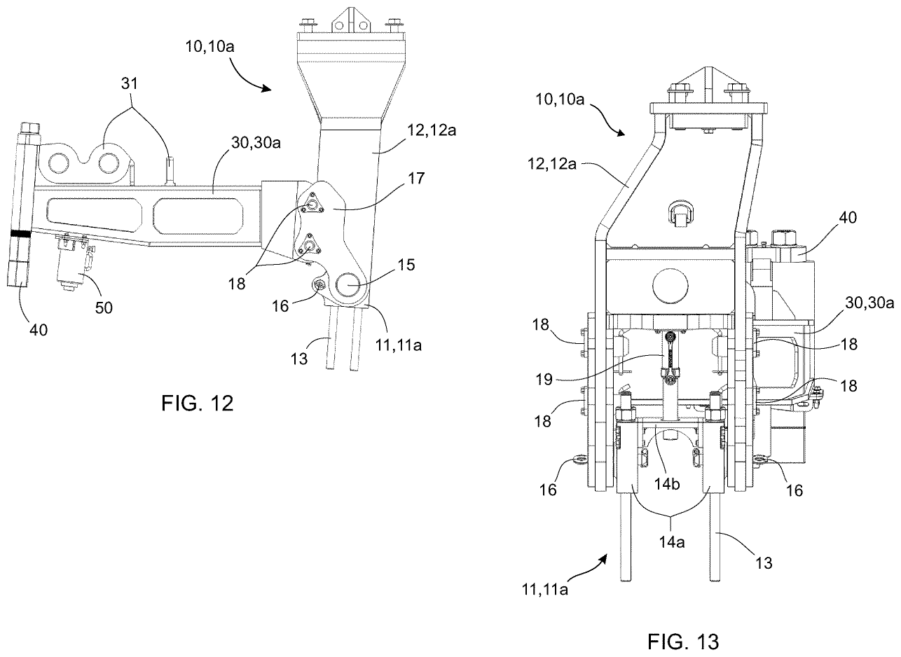

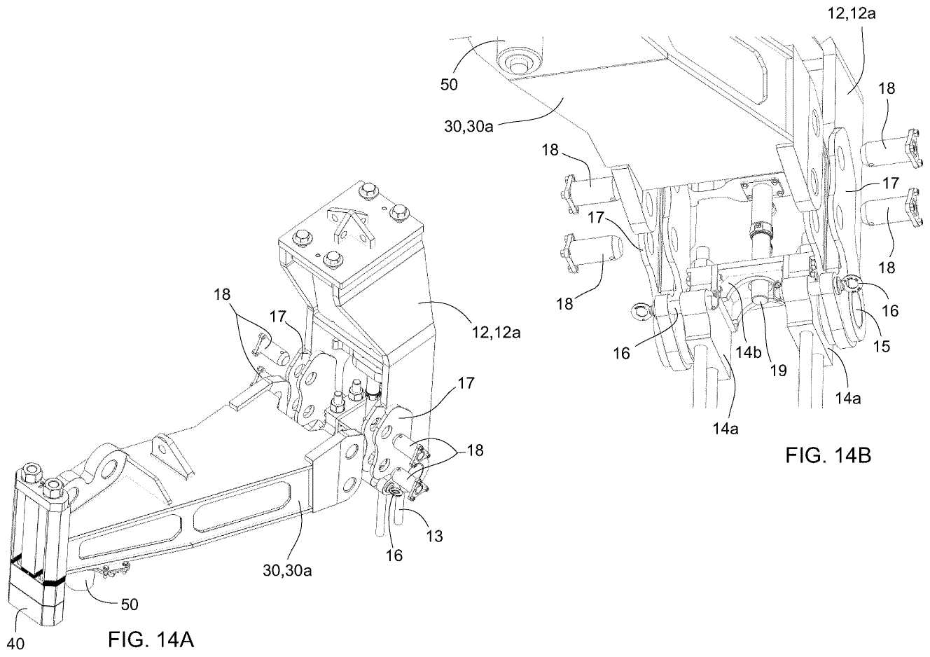

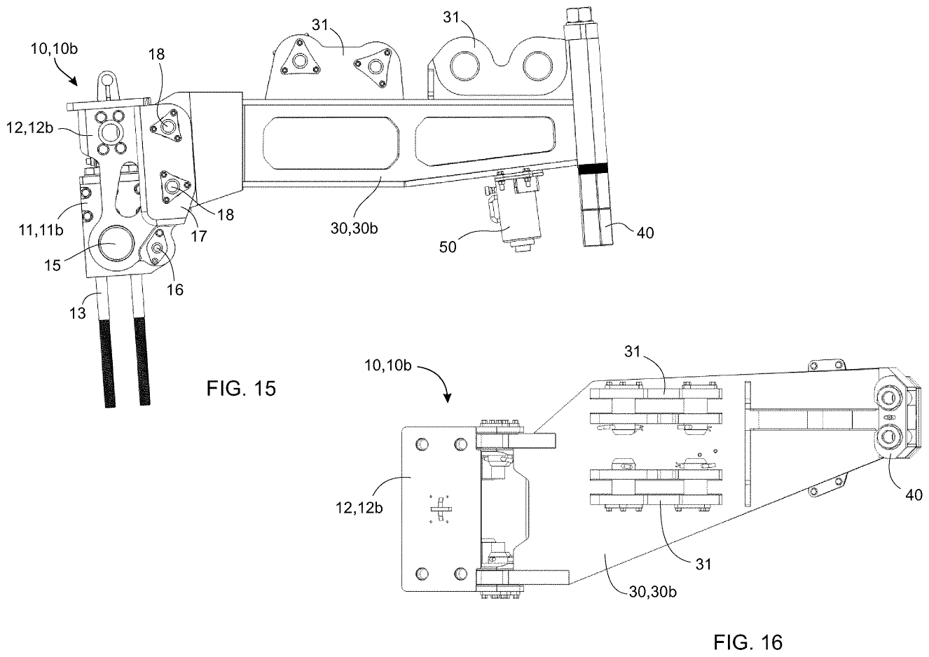

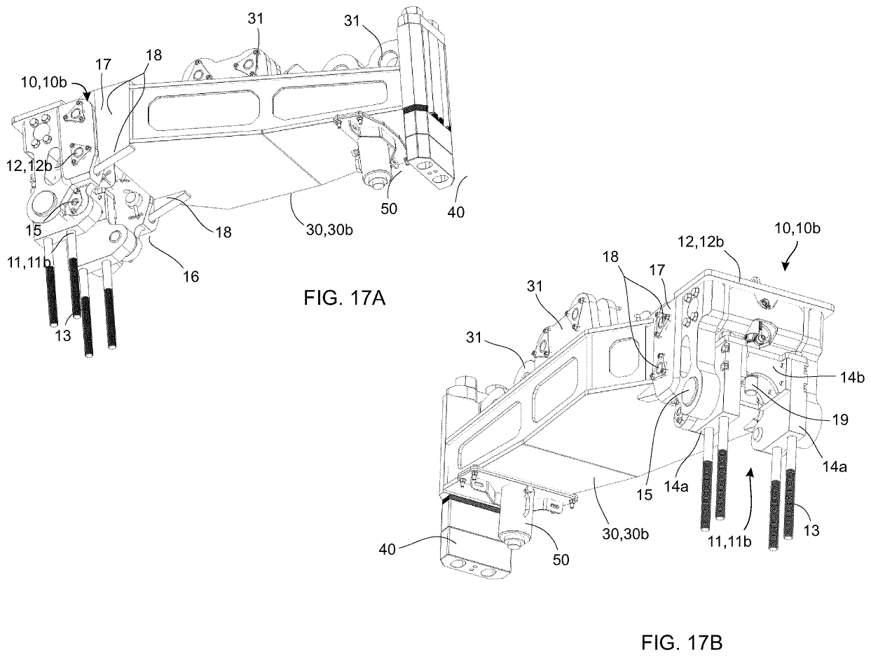

FIG. 10 to FIG. 17B illustrate the trunnion mount assemblies 10 and the longitudinal beams 30 pivotally connected to the trunnion mount assemblies 10. FIG. 10 to FIG. 14B illustrate the first trunnion mount assembly 10a and the first longitudinal beam 30a, while FIG. 15 to FIG. 17B illustrate the second trunnion mount assembly 10b and the second longitudinal beam 30b. While the first and second longitudinal beams 30a and 30b are similar and operate essentially in the same manner, the two longitudinal beams 30a and 30b are both angled inwardly (toward the main shaft 101) from their respective trunnion mount assemblies 10a and 10b, thus the two longitudinal beams 30a and 30b are mirror images of each other in this regard. In FIG. 15 to FIG. 17B, some structure of the second trunnion mount assembly 10b has been omitted.

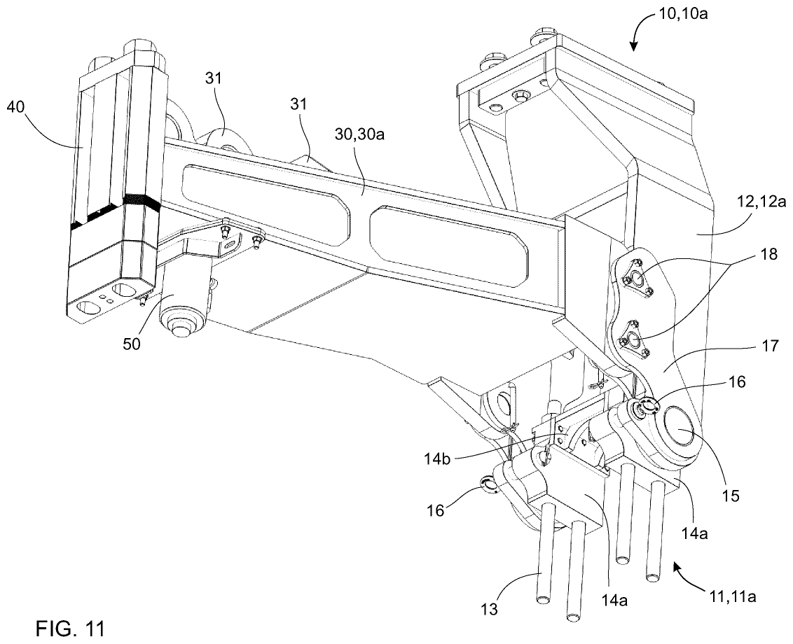

The trunnion mount assemblies 10 (individually 10a and 10b) comprise pillow block mounts 11 (individually 11a and 11b, respectively) and beam receivers 12 (individually 12a and 12b, respectively). The pillow block mounts 11 comprise transversely spaced apart blocks 14a bridged at the tops thereof by an arched plate 14b (see FIG. 11) The pillow block mounts 11 comprise studs 13 (only one labeled) downwardly depending from the spaced apart blocks 14a, which engage corresponding apertures in the front pillow blocks 102 so that the pillow block mounts 11 are mounted on respective front pillow blocks 102 through the studs 13. While the pillow block mounts 11 are illustrated with four studs 13, the number, arrangement and spacing of the studs depends on the particular pillow block configuration for the model of wind turbine. In some cases, it may be possible to use the existing studs of the pillow blocks instead of providing the pillow block mounts with their own studs. The beam receivers 12 are supported on and extend upwardly from the pillow block mounts 11. The connecting beam 2 is connected to and spans the beam receivers 12 at the tops of the beam receivers 12. The beam receivers 12 are pivotably connected to and situated on top of the pillow block mounts 11. Pivotal connections of the beam receivers 12 to the pillow block mounts 11 are made through respective trunnion pins 15, each of the trunnion mount assemblies 10 comprising two trunnion pins 15, although one or more than two trunnion pins could be employed per trunnion mount assembly 10. The trunnion pins 15 are transversely oriented with respect to a longitudinal axis of the nacelle and longitudinal axes of the longitudinal beams 30. The trunnion pins 15 are located on horizontally oriented axes about which the beam receivers 12 pivot, and about which the longitudinal beams 30 pivot. Thus, the horizontally oriented pivot axes are at the pillow block mounts 11.

The trunnion mount assemblies 10 further comprise installation locks to prevent pivoting of the beam receivers 12 about the trunnion pins 15 during installation of the base 1 in the nacelle. The installation locks comprise apertured mount lugs rigidly connected to the pillow block mounts 11 and apertured receiver lugs rigidly connected to the beam receivers 12, whereby apertures in the apertured mount lugs can be aligned with apertures in the apertured receiver lugs to receive installation pins 16 inserted therethrough through to prevent pivoting of the beam receivers 12 on the pillow block mounts 11. The installation pins 16 are preferably lockable pins, such as cotter pins, to prevent the installation pins 16 from falling out of the apertures during installation of the base 1. Once the base 1 is installed in the nacelle and the lift system 100 mounted on the base 1, the installation pins 16 are removed to permit pivoting of the beam receivers 12 on the pillow block mounts 11.

The trunnion mount assemblies 10 further comprise hydraulic cylinders 19 that are connected to undersides of and extend downwardly from the beam receivers 12. The hydraulic cylinders 19 can be actuated to engage and push on gearbox suspension pins 106, which are clamped in the front pillow blocks 102, to adjust the angle of a gearbox 107 in the nacelle when installing the main shaft 101 to match the angle of the main shaft 101 because the tolerances in the main shaft-gearbox connection are extremely tight.

The beam receivers 12 further comprise mounting brackets 17 rigidly connected to the beam receivers 12. The longitudinal beams 30 are non-pivotally, but preferably releasably, attached to the mounting brackets 17 so that the longitudinal beams 30 extend longitudinally in the nacelle between the trunnion mount assemblies 10 and the front of the nacelle. The longitudinal beams 30 have longitudinal axes extending between proximal ends of the longitudinal beams 30 located at the trunnion mount assemblies 10 and distal ends located at the main bearing 103 of the wind turbine. At the proximal ends, the longitudinal beams 30 are pinned, for example releasably pinned, to the mounting brackets 17 by receiver pins 18. While two receiver pins 18 per mounting bracket 17 are shown any number of receiver pins, for example one, two, three, four or more receiver pins per mounting bracket may be utilized. The longitudinal beams 30 are equipped with lugs 31 to provide attachment points for frame elements of the lift system 100 so that the lift system 100 can be supported on the longitudinal beams 30. The number, configuration and arrangement of the lugs 31 on the longitudinal beams 30 depends on the model of lift system to be supported. The number, configuration and arrangement of the lugs 31 on the first longitudinal beam 30a may be the same as or different than the number, configuration and arrangement of the lugs 31 on the second longitudinal beam 30b.

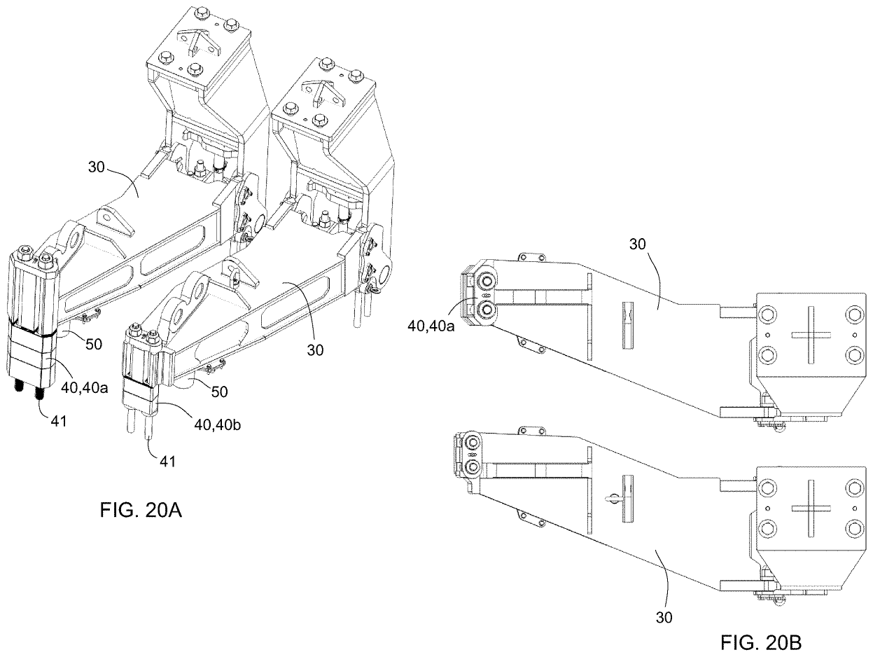

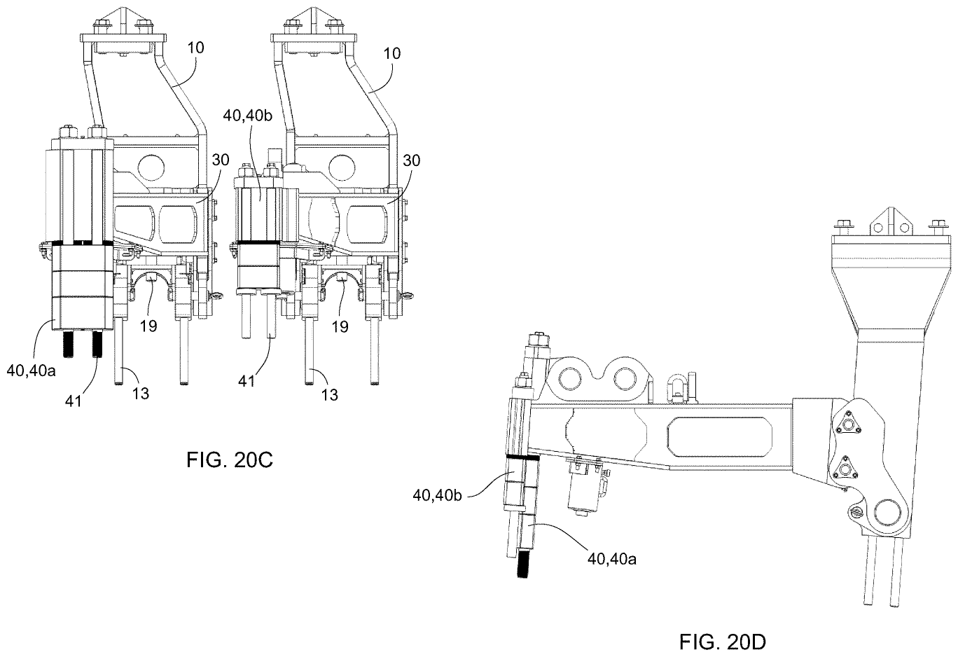

Beam supports 40 are connected to the longitudinal beams 30 to support the longitudinal beams 30 on the main bearing 103 of the wind turbine. The beam supports 40 are proximate the distal ends of the longitudinal beams 30, for example at the distal ends of the longitudinal beams 30. Different styles of beam supports 40, for example the styles 40a and 40b illustrated in FIG. 20A to FIG. 20B, can be used depending on the model of the wind turbine. Different wind turbines have different models and arrangement of main bearings and differently spaced mounting points on the main bearing, therefore different beam supports are required depending on the wind turbine in which the base 1 is to be used. The beam supports 40 may be integrally attached, for example by welding, to the longitudinal beams 30. Alternatively, the beam supports 40 may be removably connected, for example by bolting, to the longitudinal beams 30 to facilitate exchanging the beam supports without the need for new longitudinal beams 30. The beam supports may be provided with beam support studs 41 for insertion into apertures in the main bearing 103 to help retain the longitudinal beams 30 on the main bearing 103.

Jacks 50 are situated proximate the distal ends of the longitudinal beams 30. The jacks 50 are operable to engage the longitudinal beams 30 and the bedplate 104 of the nacelle to raise and lower the distal ends of the longitudinal beams 30 to pivot the longitudinal beams 30 about the horizontally oriented axis, which is through the trunnion pins 15 in the illustrated embodiment. The jacks 50 are preferably underneath the longitudinal beams 30 and above the bedplate 104. In some embodiments, the jack comprises an extensible actuator, for example a hydraulic cylinder, a pneumatic cylinder, and electric actuator, a mechanical screw and the like. The jacks 50 illustrated in the Figures are hydraulic cylinders. The jacks may be unattached to the longitudinal beams 30 and the bedplate 104, which would permit the jacks to be moved around. However, the jacks 50 are preferably rigidly attached to the longitudinal beams 30 to provide greater safety and security when using the base 1. While the jacks 50 are preferably rigidly attached to the longitudinal beams 30, the jacks 50 are also releasably attached to the longitudinal beams 30, for example by bolting, to permit rigidly attaching the jacks 50 at different locations along the longitudinal beams 30. Further, the jacks 50 may also be embedded in the longitudinal beams 30 for additional stability during operation. With the jacks 50 situated proximate the distal ends of the longitudinal beams 30, the longitudinal beams 30 have centers of gravity located between the jacks 50 and the horizontally oriented axis about which the respective longitudinal beams 30 pivot.

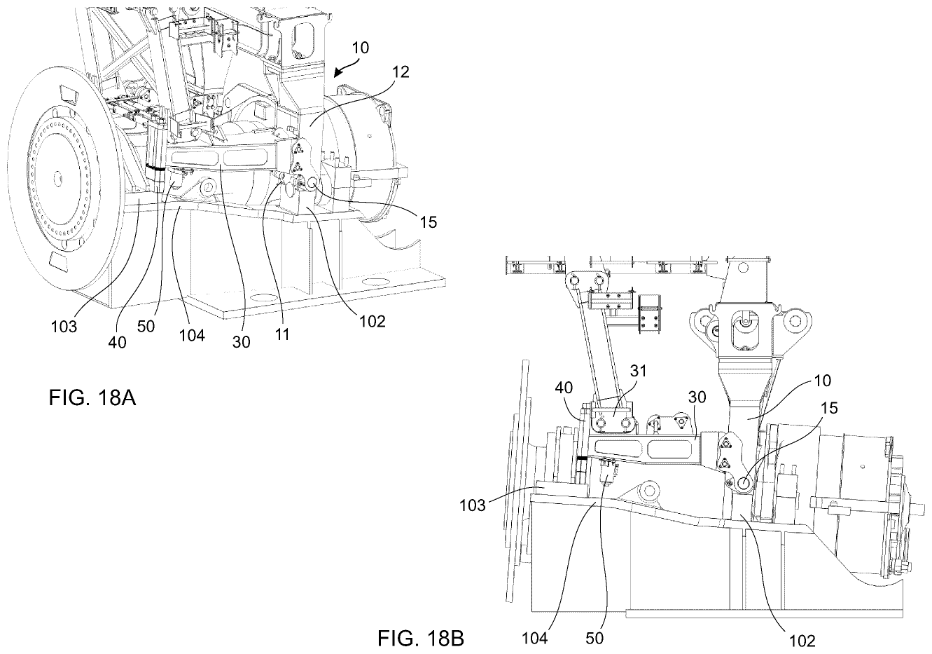

As seen in FIG. 18A and FIG. 18B, with the longitudinal beams 30 supported on the main bearing 103 and connected to the respective trunnion mount assemblies 10, the longitudinal beams 30 can support the weight of the lift system 100 as the lift system 100 lifts a heavy component of the wind turbine. In this configuration of the base 1, the lift system 100 is usable for mounting and dismounting the rotor or individual rotor blade, which is a very heavy wind turbine component. Removing the installation pins 16 permits the longitudinal beams 30 to pivot about the trunnion pins 15 at the proximal end (i.e., the rear) of the longitudinal beams 30 while the lift system 100 is lifting a load, for example the rotor or individual rotor blade. Pivoting at the rear of the longitudinal beams 30 allows a heavy weight to be supported on the longitudinal beams 30 without increasing bending load on any of the studs 13 of the pillow block mounts 11. The pivoting of the longitudinal beams 30 at the rear of the longitudinal beams 30 proximate or at the pillow block mounts 11 equalizes the vertical tensile load on the studs 13 when a heavy weight is supported on the longitudinal beams 30, while still permitting the nacelle to freely yaw. The pivoting of the longitudinal beams 30 about the trunnion pins 15 at the rear of the longitudinal beams 30 also permits mounting the base 1 to only one of set of pillow blocks, for example the front pillow blocks 102. Furthermore, the longitudinal beams 30 can be easily adapted to work with different bedplate generations of various wind turbines.

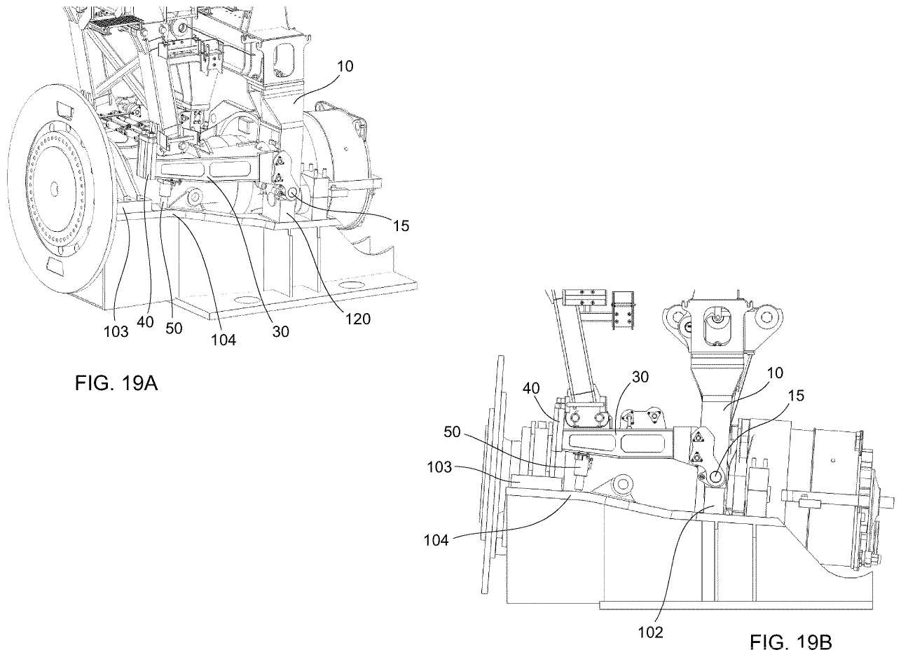

While the equalization of load on the studs 13 of the pillow block mounts 11 is advantageous in and of itself, the base 1 is also reconfigurable to permit the lift system 100, already mounted on the base 1, to lift the main bearing 103, advantageously without the need for a complex launching device, without removing the base 1 from the nacelle and without adding extra components to the base, such as the side supports that are added when the base described in DK 202170204 is reconfigured. To accomplish the reconfiguration of the base 1, the jacks 50 are actuated to extend to engage the base plate 104, as seen in FIG. 19A and FIG. 19B. In the illustrated embodiment, the extending jacks 50 engage the base plate 104 at positions proximate to but rearward of the main bearing 103. Continued extension of the jacks 50 raises the distal ends of the longitudinal beams 30, the longitudinal beams 30 pivoting about the trunnion pins 15 at the proximal end of the longitudinal beams 30. Raising the distal ends of the longitudinal beams 30 lifts the beam supports 40 off the main bearing 103 until the beam supports 40 are lifted to a height sufficient to permit the lift system 100 to lift and dismount the main bearing 103. Likewise, a main bearing can be mounted in the nacelle while the jacks 50 support the distal ends of the longitudinal beams 30 on the bedplate 104. Thus, the base 1 is reconfigurable to switch between lifting the rotor and the main bearing with minimal effort and without needing to remove the base 1 or add components to the base 1. In addition, once the base 1 is switched from rotor lifting to main bearing lifting and the main bearing 103 removed, the distal ends of the longitudinal beams 30 can be lowered by the jacks 50 and the beam supports 40 connected to the bedplate 104 through the beam support studs 41. Thus, with minimal reconfiguration, of the base 1, the lift system 100 can also then be used to lift the gearbox. Further, the base 1 avoids the need to support the lift system 100 on the low-speed rotor lock when lifting the main bearing, which is a problem with some designs shown in DK 202170204. The use of the jacks 50 proximate the distal ends of the longitudinal beams 30 helps avoid complicated base reconfiguration from rotor lifting to main bearing and gearbox lifting.

The novel features will become apparent to those of skill in the art upon examination of the description. It should be understood, however, that the scope of the claims should not be limited by the embodiments but should be given the broadest interpretation consistent with the wording of the claims and the specification as a whole.

1. A base for supporting a lift system in a nacelle of a wind turbine, the base comprising:
a pillow block mount configured to be supported on a pillow block in the nacelle of the wind turbine, the pillow block mount mountable on the pillow block through studs connecting the pillow block mount to the pillow block;
a longitudinal beam pivotally connected to the pillow block mount, the longitudinal beam having a longitudinal axis, a proximal end proximate the pillow block mount and a distal end remote from the pillow block mount, the longitudinal beam pivotable about a horizontally oriented axis transverse to the longitudinal axis of the longitudinal beam;
a beam support connected to the longitudinal beam, the beam support configured to support the longitudinal beam on a main bearing of the wind turbine proximate the distal end of the longitudinal beam; and,
a jack situated proximate the distal end of the longitudinal beam, the jack operable to engage the longitudinal beam and a bedplate of the nacelle to raise and lower the distal end of the longitudinal beam to pivot the longitudinal beam about the horizontally oriented axis.

2. The base of claim 1, wherein the jack comprises an extensible actuator.

3. The base of claim 2, wherein the extensible actuator comprises a hydraulic cylinder.

4. The base of claim 1, wherein the jack is rigidly attached to the longitudinal beam.

5. The base of claim 4, wherein the jack is releasably attached to the longitudinal beam to permit rigidly attaching the jack at different locations along the longitudinal beam.

6. The base of claim 1, wherein the longitudinal beam has a center of gravity, the center of gravity located between the jack and the horizontally oriented axis about which the longitudinal beam pivots.

7. The base of claim 1, wherein the horizontally oriented axis is proximate the pillow block mount.

8. The base of claim 7, wherein the horizontally oriented axis is at the pillow block mount.

9. The base of claim 1, further comprising a trunnion mount assembly, the trunnion mount assembly comprising the pillow block mount and a beam receiver,
the pillow block mount comprising at least one transversely oriented trunnion pin located on the horizontally oriented axis about which the longitudinal beam pivots,
the beam receiver pivotally mounted to the pillow block mount through the at least one trunnion pin, the longitudinal beam non-pivotably attached to the beam receiver such that the longitudinal beam pivots about the at least one trunnion pin when the beam receiver pivots about the at least one trunnion pin.

10. The base of claim 9, wherein the at least one trunnion pin comprises two trunnion pins.

11. The base of claim 9, wherein the longitudinal beam is releasably attached to the beam receiver.

12. The base of claim 9, wherein the longitudinal beam is pinned to the beam receiver by at least one receiver pin.

13. The base of claim 1, wherein the beam support is removably connected to the longitudinal beam to permit exchanging the beam support for a different beam support.

14. The base of claim 1, wherein the pillow block is a front pillow block.

15. The base of claim 1, wherein:
the pillow block mount comprises first and second pillow block mounts;
the longitudinal beam comprises first and second longitudinal beams pivotally connected to the first and second pillow block mounts, respectively;
the beam support comprises first and second beam supports connected to the first and second longitudinal beams, respectively; and,
the jack comprises first and second jacks operable to engage the first and second longitudinal beams, respectively.

16. The base of claim 15, wherein:
the first and second pillow block mounts are transversely spaced apart and supported on respective pillow blocks when the base is in the nacelle with a main shaft of the wind turbine situated between the first and second pillow block mounts; and,
the base further comprises a transverse connecting beam on which the lift system is supported in the nacelle over the main shaft, the connecting beam spanning the first and second pillow block mounts.
